(19) United States
(12) Patent Application Publication
(10) Pub. No.: US 2021/0032081 A1
(43) Pub. Date: Feb. 4, 2021

(54) Blade Crane

(71) Applicant: Cooke Power, Amarillo, TX (US)

(72) Inventor: Matt JOHNSON, Amarillo, TX (US)

(21) Appl. No.: 16/983,744

(22) Filed: Aug. 3, 2020

Related U.S. Application Data
(60) Provisional application No. 62/881,615, filed on Aug. 1, 2019.

(51) Int. Cl. B66C 23/20; F03D 13/10

(52) U.S. Cl. CPC B66C 23/207; B66D 1/60; F05D 2230/68; F03D 13/10

(57) ABSTRACT

A system and method for a blade crane. The crane has a blade coupler which is used to attach to a blade. An arm extends outward from the blade coupler. A cable is coupled to the arm, and the cable is allowed to extend and retract.

### PRIORITY

The present invention claims priority to Provisional Application No. 62/881,615 filed Aug. 1, 2019, the entirety of which is hereby incorporated by reference.

### BACKGROUND OF THE INVENTION

### Technical Field

The present invention relates to a system and method for a coupled crane.

### Description of Related Art

Wind turbines are becoming increasingly popular and common. These are generally very large and very tall. As such, maintenance on the turbines is often difficult because it must be performed at high elevation which requires bringing tools, equipment, and personnel to heights as well. Consequently, there is a need for a system and method of bringing tools, equipment, personnel, etc. up to the wind turbine.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a wind turbine in one embodiment;

FIG. 2 is a perspective view of a wind turbine in one embodiment;

FIG. 3 is a perspective view of a blade crane in one embodiment;

FIG. 4 is a perspective view of a wind turbine with an extended winch in one embodiment;

FIG. 5 is a perspective view of a blade crane installed on a blade in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

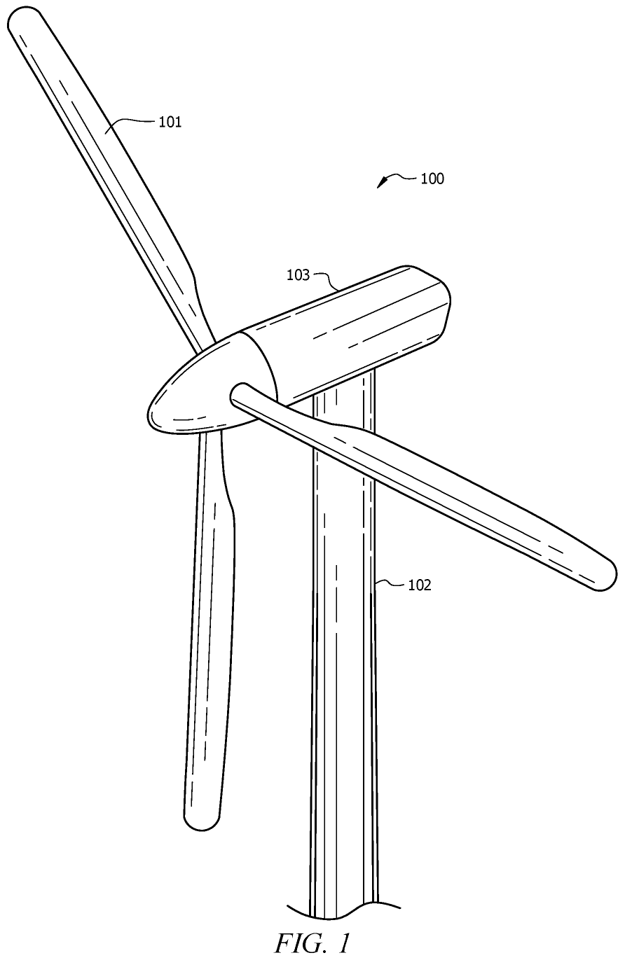

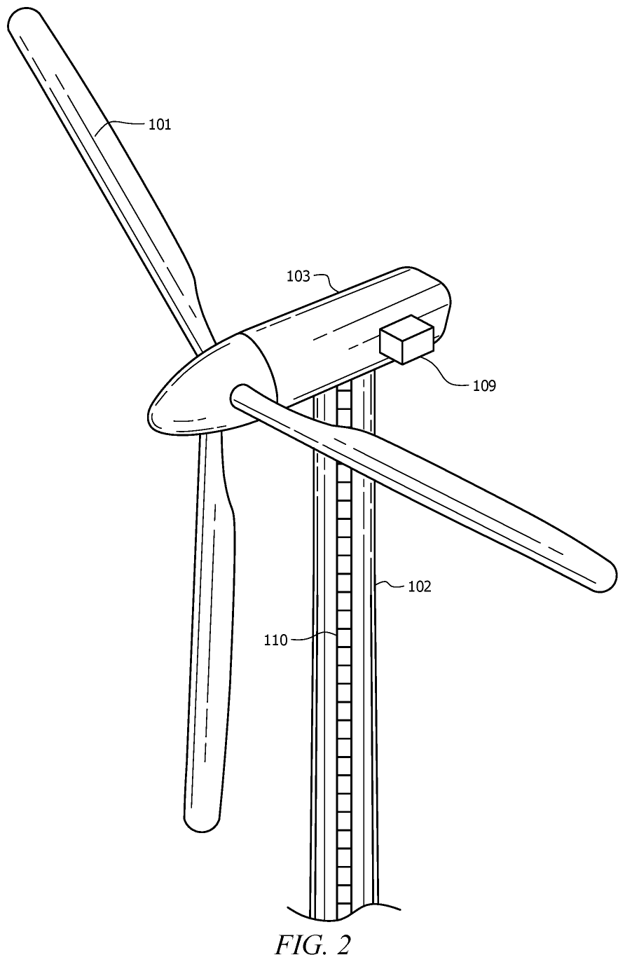

FIG. 1 is a perspective view of a wind turbine in one embodiment. As depicted the wind turbine 100 comprises blades 101a pole 102, and a turbine 103. The size, dimension, and type of the wind turbine can be adjusted depending upon the desired application. As shown the pole 102 is vertical and the blades 101 extend radially away from the pole. As shown in FIG. 2, the blades 101 are coupled to the turbine 103 and extend radially away from an end of the turbine 103.

As depicted the wind turbine 100 comprises three blades 101. This is for illustrative purposes only and should not be deemed limiting. The system and method discussed herein can be applied on a wind turbine 100 having virtually any number of blades.

When the blades 101 are turned by wind, the turbine 103 converts the movement of the blades 101 into electricity. The system and method discussed herein is not limited to any specific turbine 103 size, type, or brand. Further, while a turbine is discussed, this is for illustrative purposes only and should not be deemed limiting. Other structures which use wind, such as wind mills, can also utilize the system and method discussed herein.

The wind turbines 100 are generally large and very high. When the wind turbine 100 requires maintenance and replacement parts, a crane is generally required to haul the parts to the desired location to be installed. The cranes are very expensive. Further, wind turbines are often placed in remote locations requiring significant, and expensive, time for the crane to reach the wind turbine. Elimination of the dependence of the crane results in significant savings in time and money. Further, an inoperable turbine results in decreased output and lost revenue. Every hour that the operator waits for a crane is lost revenue. Thus, having a system and method providing for operation on the turbine without requiring a crane results in cost savings.

FIG. 2 is a perspective view of a wind turbine in one embodiment. As shown the wind turbine 100 comprises a ladder 110. This allows personnel to climb and access the turbine 103.

Often the wind turbine 100 comprises a turbine winch 109. A turbine winch 109, as discussed herein, refers to an on-board winch system which is located on the wind turbine 100. As depicted, the turbine winch 109 is depicted as being located on and within the turbine 103.

Typically, the turbine winch 109 is not rated to carry or support the weight of many parts or components of the wind turbine 100. Thus, while the turbine winch 109 can be used to lift lighter components from the ground and bring them to the turbine 103, the application of the turbine winch 109 is limited. In situations wherein the weight of the components to be lifted exceed the weight rating of the turbine winch 109, which is common, then typically a separate crane will be required as described above.

As will be described below, however, a blade crane 108 can be utilized to lift heavier components which are outside of the weight rating of the turbine winch 109. This eliminates the need for a costly crane. As such, the system and method discussed herein significantly reduces the cost of repair, maintenance, and up-keep on wind turbines.

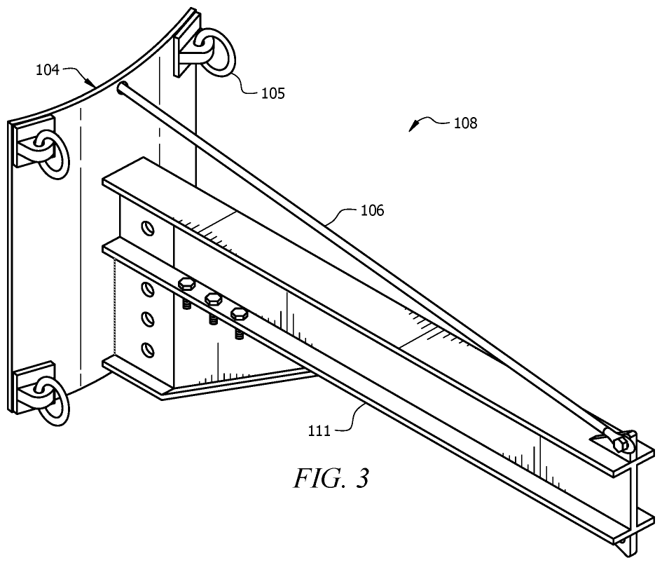

FIG. 3 is a perspective view of a blade crane in one embodiment. The blade crane 108 includes a blade coupler 104. The blade coupler 104 is used to couple to a blade 101 of a wind turbine 100. As depicted, the face of the blade coupler 104 is curved to mimic the curvature of the blade 101. This allows for a closer fit between the blade coupler 104 and the blade 101.

As depicted the blade crane 108 further comprises one or a plurality of coupler supports 105. As shown, the blade crane 108 comprises four coupler supports 105. Coupler supports 105 are elements which allow the blade crane 108 to be coupled to the blade 101. In one embodiment wire or cable is inserted through the coupler support 105, wrapped around the blade 100, and attached to the coupler support 105. In this fashion, the blade crane 108 can be coupled and decoupled to the wind turbine 100.

Attached to and extending away from the blade coupler 104 is the arm 111. The arm 111 can extend from the coupler 104 at virtually any angle. In one embodiment the arm 111 is approximately perpendicular to the coupler 104.

The length of the arm can vary depending upon the desired application. In some embodiments a longer arm 111 means that the object can be positioned closed to the turbine 103.

The arm 111 provides a support for the cable 106. While the term cable is used, this is for illustrative purposes only and should not be deemed limiting. The cable 106 can comprise a rope, cable, wire, etc. or virtually any flexible item which couples the blade crane 108 to an object to be lifted. The cable 106 can be lowered down to the ground, coupled to an object, and then lifted upward. The cable 106 can be coupled to any type of winch system which can control and lower the cable 106.

The blade crane 108 can comprise virtually any type of material. The blade crane 108 can comprise metal, plastics, wood, and combinations thereof. One skilled in the art will understand that the weight rating of the crane 108 will be partially dependent upon the materials selected for construction.

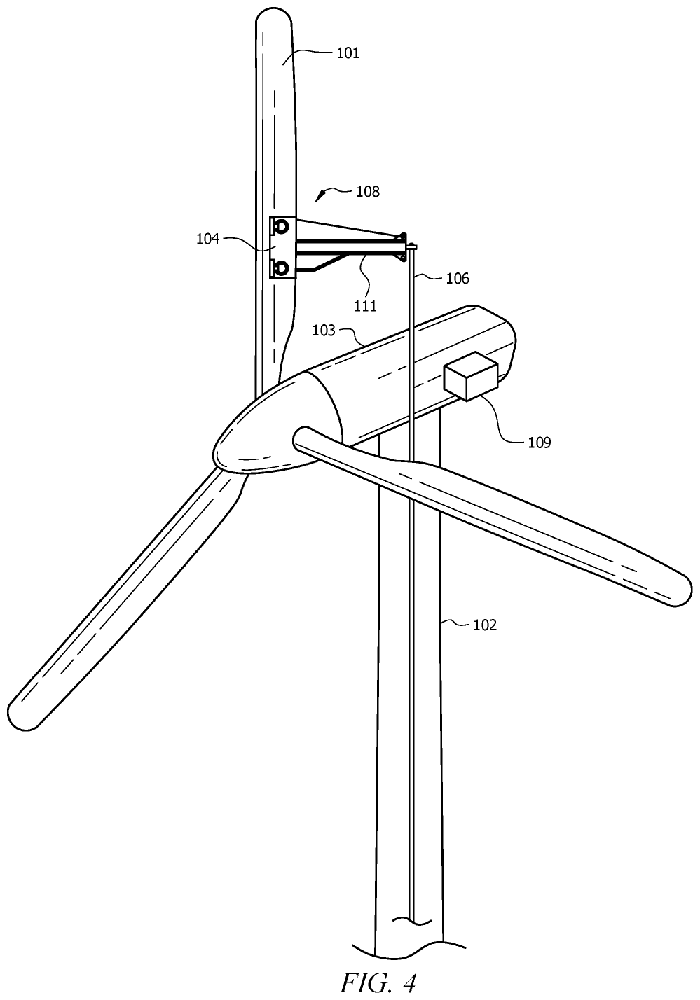

FIG. 4 is a perspective view of a wind turbine with an extended winch in one embodiment. As shown the crane 108 is depicted as being coupled to the blade 101. The arm 111 extends outward from the coupler support 104.

The cable 106 extends downward from the arm 111 and extends to the ground. On the ground, the cable 106 can be coupled to an object, such as a component or replacement part for the turbine 103. The cable 106 can then be retracted to pull the object upward toward the turbine 103. In some embodiments the arm 111 comprises a pulley or other such system. In such embodiments the cable 106 will extend upward to and downward from the pulley. A force can be applied downward on one end of the cable 106 causing the other end of the cable 106 to lift. This allows objects on the ground to be lifted upward to the arm 111.

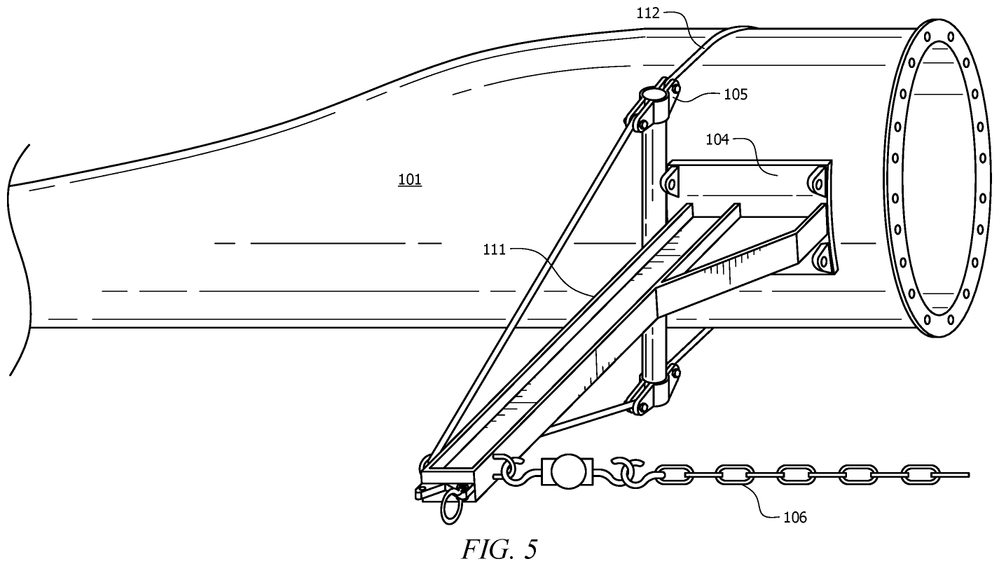

FIG. 5 is a perspective view of a blade crane installed on a blade in one embodiment. As can be seen, the blade coupler 104 is curved to mimic the surface of the blade 101. This allows for a more secure and intimate fit. As shown a coupler 112 is wrapped around the blade 101 and coupled to the coupler support 105. When a downward force is applied on the cable 106, the blade coupler 104 will press upon the blade 101. The coupler 112, in conjunction with the blade coupler 104, will ensure the blade crane remains in the desired location.

FIG. 5 shows the blade crane already installed on a blade 101 on the ground. While an embodiment is described below wherein the blade crane is installed on a blade 101 in the air, this is for illustrative purposes only and should not be deemed limiting.

The blade crane 108 can be installed in a variety of ways. In one embodiment the blade 101 is positioned to be in the upward position, as depicted in FIG. 4. At that point, a brake is applied to ensure the blade 101 remains the desired position.

Next, an operator will utilize the onboard turbine winch 109, if available. If the onboard turbine winch 109 is not available, then other winches or cranes can be used to install the blade crane 108. The onboard turbine winch 109 will likely be sufficiently rated to hoist the blade crane 108. The cable of the turbine winch 109 is lowered where it is coupled to the blade crane 108.

The blade crane 108 is lifted via the onboard turbine winch 109. The blade coupler 104 is positioned by the winch 109 to position adjacent the blade 101. Thereafter, the coupler 104 is coupled to the blade 101 with cables, wire, etc. by using the coupler support 105. The blade crane 108 now properly secured, is disconnected from the turbine winch 109.

The cable 106 is then deployed down to the ground and coupled to an object to be retrieved. In one embodiment the cable 106 can be controlled remotely from the ground. Thus, an operator located safely on the ground can lower the cable 106, connect the cable to an object, and raise the object by retracting the cable 106.

Once the object is pulled upward adjacent to the turbine 103, an operator can position and retrieve the object and use it as necessary to repair and maintain the turbine 103. The old part, if necessary, can be coupled to the cable 106 and lowered down using the same process. Additional parts, if necessary, are retrieved or deployed in the same fashion described above.

Once all parts have been retrieved or removed, the blade crane 108 is reattached to the onboard turbine winch 109. The blade crane 108 is decoupled from the blade 101 and subsequently removed. Thereafter, the turbine winch 109 is stored, and the brake released. Thereafter, the wind turbine 100 is allowed to function and move as intended.

As noted, the system and method disclosed herein has a plurality of benefits. First, is decreased costs associated with renting a crane. As noted, cranes which are rated highly enough to accommodate the height of wind turbines and the weight associated with the components are often very expensive. Not only must operators pay for the cranes time on-site, but they must also pay for the crane to travel to and from the often remote location. The system and method disclosed herein allows a traditional truck to carry the blade crane 108 to and from the wind turbine. Thus, rather than pay the expensive rates to rent a crane, the operator must simply pay for use of a commercial truck and the blade crane 108.

Another advantage is decreased downtime. As noted, without a blade crane 108 specialized and expensive cranes were necessary. If the cranes were being utilized in a different job, then the wind turbine would need to be shut down and wait until the cranes could reach the broken wind turbine. This results in significant down time. Further, ensuring the parts were delivered in time to be loaded/unloaded by the time the crane arrived is often a logistical difficulty. Thus, the system and method disclosed herein decreases downtime because the user need not wait until a crane can reach the wind turbine in question. Rather, the blade crane 108 can be delivered to the wind turbine using a traditional truck.

In one embodiment a plurality of blade cranes 108 are housed in a fleet of trucks. The blade cranes 108 can be stored on trailers. Then, when a wind turbine operator needs assistance, the blade crane 108 can be brought to the job site.

In other embodiments, however, a series of wind turbine, known as a wind farm, will have an on-site blade crane. When a turbine needs service, repair, or maintenance, the blade crane 108 is positioned as necessary to be installed on the wind turbine.

While the invention has been particularly shown and described with reference to a preferred embodiment, it will be understood by those skilled in the art that various changes in form and detail may be made therein without departing from the spirit and scope of the invention.

What is claimed is:

1. A blade crane comprising:
a blade coupler;
an arm extending outward from said blade coupler;
a cable coupled to said arm, wherein said cable is elongated and allowed to extend and retract.

2. The blade crane of claim 1 wherein said blade coupler comprises a curved surface.

3. The blade crane of claim 1 further comprising coupler supports coupled to said blade coupler.

4. The blade crane of claim 3 wherein said blade coupler is coupled to a blade via said coupler supports.

5. The blade crane of claim 4 wherein a cable is inserted through said coupler supports and wrapped around said blade.

6. The blade crane of claim 4 wherein blade is located on a wind turbine, wherein said wind turbine comprises a vertical pole, at least three blades, and a turbine.

7. The blade crane of claim 5 wherein said turbine comprises a turbine winch.

8. The blade crane of claim 1 wherein said arm is approximately perpendicular to said blade coupler.

9. The blade crane of claim 1 wherein said arm comprises a pulley.

10. A method of lifting an object to a wind turbine, said method comprising:
a) attaching a blade crane to a turbine winch;
b) installing said blade crane onto a blade;
c) coupling a cable attached to said blade crane to an object;
d) lifting said object by retracting said cable;
d) removing said blade crane.

11. The method of claim 10 wherein said removing of said blade crane comprises removing said blade crane via said turbine winch.

12. The method of claim 10 further comprising applying a brake on said blade.
